(19) United States
(12) Patent Application Publication
(10) Pub. No.: US 2004/0242286 A1
(43) Pub. Date: Dec. 2, 2004

(54) Configurable network initiated response to mobile low battery condition

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/447,019

(22) Filed: May 28, 2003

(51) Int. Cl. H04M 1/00; H04B 1/38

(52) U.S. Cl. 455/574; 455/414.1

(57) ABSTRACT

A method and system provides notification to a battery powered communication device, from a telecommunications network, of a low battery condition of the battery powered communication device. In one embodiment, the method may have the steps of: monitoring a device battery level condition of a battery powered communication device; determining, by a telecommunication network, when the device battery level condition of the battery powered communication device transgresses at least one predetermined battery level condition; and effecting, by the telecommunication network via a network initiated call to the battery powered communication device, at least one predetermined action at the battery powered communication device in response to the transgression of the at least one predetermined battery level condition by the current device battery level condition of the battery powered communication device. The system implements the method.

### TECHNICAL FIELD

The present invention relates to wireless telephony in general, and, more particularly, to a method and system for providing a network initiated call to a mobile phone from a telecommunications network to inform a mobile user of a low battery condition of the mobile phone.

### BACKGROUND OF THE INVENTION

Wireless devices and telephones, which include both cellular telephones and the higher frequency personal communication devices (PCDs), are growing in numbers and also shrinking in size and weight. The growth in numbers is influenced by the convenience and the per call cost of wireless telephones with respect to pagers and wire line telephones or coin telephones for completing calls, especially when the user is away from home or office. The shrinking size is influenced by two related technologies: more efficient receive/transmit processing circuits and higher power density batteries.

Wireless communications devices are typically powered from a battery contained within the device. Battery levels decrease due to use of the wireless device. Since batteries exhibit behavior which varies from charge cycle to charge cycle, and over the life of the battery, and because wireless devices typically have varying power requirements depending upon the conditions under which they are utilized, it is often difficult to detect exactly when battery capacity will fall to level at which operation of the wireless device fails. Often, a battery will fail in the middle of an operation or task that the wireless device is performing resulting in termination of wireless communications between the wireless device and a base station. For example, a mobile user may be talking on a cell phone and suddenly hear a beeping noise that indicates the battery is low. Usually after a few minutes or less of talk time, the battery runs out and the call is lost.

Prior systems that monitor battery level typically provide either an audio or visual warning signal to the user of the wireless device upon detection of a low battery state. If the warning signal is a visual signal, e.g., a blinking light or LED, it is difficult to see the warning light when the wireless device is placed out of sight, for example when a cell telephone is placed to the ear during use. Furthermore, the time left from the warning till the battery completely dies is too short for the mobile user to do anything. Thus, there lies a need for a system and method of notifying and handling a low battery at a more appropriate level in a wireless device.

Therefore, there is a need in the art for an improved system and method for handling a low battery level condition in a cell phone or other battery powered device. In particular there is a need to provide a solution to the problem that when a prior art mobile phone signals a user that the battery is low, it is almost too late. There is little talk time left, and often times there is not enough battery life left to even finish the current conversation.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of an embodiment of the present method and system to provide a method and system for, especially on a mobile phone in a telecommunications network, providing a network initiated call to a mobile phone from a telecommunications network to inform a mobile user of a low battery condition of the mobile phone.

It is a further aspect of an embodiment of the present method and system to provide a network initiated call to a mobile phone from a telecommunications network to inform a mobile user of a low battery condition of the mobile phone according to user prescribed battery level thresholds.

It is a further aspect of an embodiment of the present method and system to report the battery condition of the mobile phone via a pilot strength measurement message (PSMM) from the mobile phone to the basestation.

It is a further aspect of an embodiment of the present method and system for the basestation to forward the mobile battery condition information to the Mobile Switching Center (MSC) for threshold comparison and subsequent action.

It is a further aspect of an embodiment of the present method and system to provide a network initiated call to a mobile phone from a telecommunications network to inform a mobile user of a low battery condition of the mobile phone wherein the mobile user has a plurality of options for continue use of the mobile phone or other battery powered device.

In very general terms the present system and method provides notification to a battery powered communication device from a telecommunications network of a low battery condition of the battery powered communication device. In one embodiment, the method may have the steps of: monitoring a device battery level condition of a battery powered communication device; determining, by a telecommunication network, when the device battery level condition of the battery powered communication device transgresses at least one predetermined battery level condition; and effecting, by the telecommunication network via a network initiated call to the battery powered communication device, at least one predetermined action at the battery powered communication device in response to the transgression of the at least one predetermined battery level condition by the current device battery level condition of the battery powered communication device.

Also, in general terms one embodiment of a system, in which the method is implemented, may have: a communication network operatively connected to a battery powered communication device; the battery powered communication device having a battery level monitoring module, the battery level monitoring module outputting a current battery level indicative thereof; a pilot strength measurement message containing at least the current battery level, the pilot strength measurement message being sent from the battery powered communication device to the communication network; and a comparison module in the communication network, wherein the comparison module compares the current battery level to at least one stored predetermined battery level. The telecommunication network, via a network initiated call to the battery powered communication device, effects at least one predetermined action at the battery powered communication device in response to the transgression of the at least one predetermined battery level condition by the current device battery level condition of the battery powered communication device.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a mobile switching center, base station and mobile station for use with the present method and system.

FIG. 2 illustrates a more detailed block diagram illustrative of a mobile switching center, base station, and mobile station according to one embodiment of the present method and system.

FIG. 3 illustrates a very general flow chart of logical operational steps that may be followed in accordance with one embodiment of the present method and system.

FIG. 4 illustrates another flow chart of logical operational steps that may be followed in accordance with one embodiment of the present method and system.

FIG. 5 illustrates yet a further flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

In one embodiment the present method may provide for a network initiated call to a mobile phone from a telecommunications network to inform a mobile user of a low battery condition of the mobile phone. In very general terms an embodiment of the method may have the steps of: defining, by a battery powered communication device, at least one predetermined battery level condition at; and controlling, by the communication network, notification of a transgression of the at least one predetermined battery condition by a current device battery level condition of the battery powered communication device.

One advantage of this system and method is that, even though the communication network controls notification to the mobile phone, a mobile user may define the battery thresholds (predetermined battery conditions) and requested actions to be taken at these thresholds. Also, the mobile phone (battery powered communication device) reports its battery level to the network on the pilot strength measurement message.

Pilot strength measurement messages are well known in the wireless communications field. One example of a process, in which pilot strength measurement messages (PSMM) are utilized, is an acknowledgment process of a base station for the PSMM according to the existing IS-95B and J-STD-008 standard rules. In this example, the mobile station selects one of the two neighbor base stations according to the pilot strength threshold value, and the mobile station generates the PSMM and transmits the PSMM.

First, for a PSMM requesting an acknowledgment, the mobile station establishes a message sequence number and an acknowledgment required indicator and transmits the PSMM to the corresponding base station through a reverse traffic channel. The mobile station stores the message sequence number corresponding to the PSMM requesting the acknowledgment and stores acknowledgment status indicators. If a positive acknowledgement is received, the mobile station does not transmit a new message requesting a response. Thus, when a new PSMM is transmitted to the base station through the reverse traffic channel, the mobile station sets parameters of the PSMM to first values and stores them. Thereafter, when the acknowledgment for the PSMM is received from the base station through the forward traffic channel, the parameters are set to second values for the transmitted PSMM. At this time, the base station makes a response by modifying the received message and by transmitting it.

After the mobile station transmits the acknowledgment requesting PSMM to the base station, the mobile station drives a timer for time limit. If the mobile station does not gain the acknowledgment from the base station until the time limit is passed, the mobile station retransmits the PSMM that has the identical message sequence number to the base station. At this time, whenever the mobile station retransmits the corresponding PSMM, the number of retransmissions, that is a retry count number, is stored. If the retry count number exceeds a maximum value, the mobile station declares that the call has been dropped.

When the mobile station moves, in order to establish a base station according to the pilot strength threshold value, the mobile station generates a first PSMM and then transmits the first PSMM to the base station. After transmitting the acknowledgment requesting first PSMM, the mobile station drives a timer for a time limit.

If the mobile station does not gain the acknowledgment from the base station until the time limit is passed, the mobile station retransmits the first PSMM that has the identical message sequence number to the base station.

When the mobile station keeps moving, in order to establish a new base station according to a new pilot strength threshold value, the mobile station generates a second PSMM and then transmits the acknowledgment requesting the second PSMM to the base station. After transmitting the acknowledgment requesting second PSMM, the mobile station drives the timer for the time limit and waits for the acknowledgment of the base station. If the mobile station does not gain the acknowledgment from the base station until the time limit is passed, the mobile station retransmits the second PSMM that has the identical message sequence number to the base station.

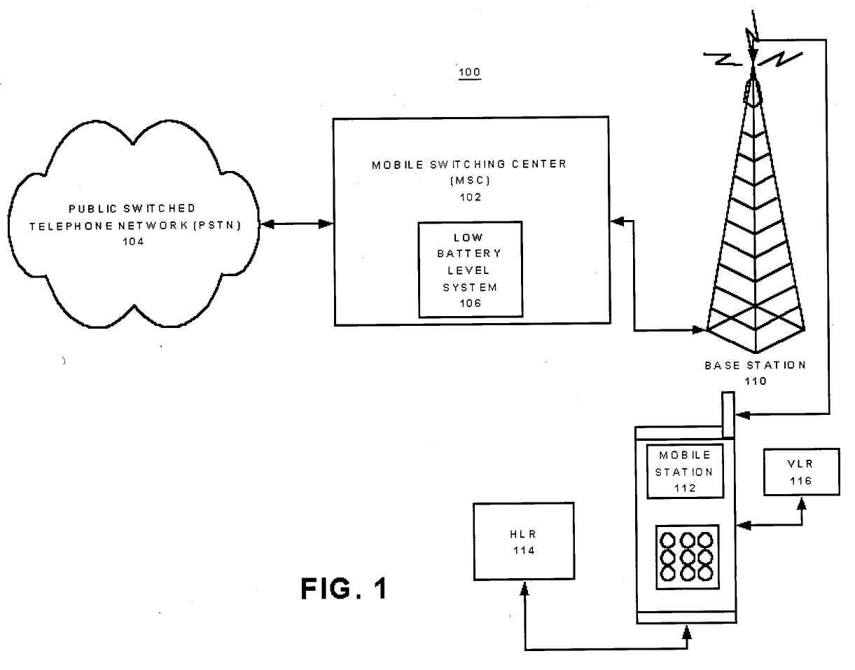

Referring to FIG. 1, a system 100 is depicted for implementing a network initiated call to a mobile phone from a telecommunications network to inform a mobile user of a low battery condition of the mobile phone according to user prescribed battery level thresholds. The mobile phone may also be any type of battery powered communication device. Communication network or system 100 may have a mobile switching center (MSC) 102. The system may be, or may be part of, one or more of a telephone network, a local area network (“LAN”), the Internet, and a wireless network. In the depicted embodiment, a public switched telephone network (PSTN) 104 is connected to MSC 102. The PSTN 104 routes calls to and from mobile users through the MSC 102. The MSC 102 is also connected to one or more base stations (BS) 110. Each of the base stations 110 communicates with mobile station(s) 112 in its service area. The PSTN 104 generally can be implemented as the worldwide voice telephone network accessible to all those with telephones and access privileges (e.g., AT&T long distance network).

Each of the mobile stations 112 has a home location register (HLR) 114 where data about each of the mobile stations 112 resides. Some of the mobile stations 112 may be remotely located from their home location, and in that case, a visiting location register (VLR) 116 is set up locally for each mobile station 112 that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 can be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, can be implemented as a local database maintained by the cellular provider whose territory is being roamed. Mobile station 112 can be implemented as a cellular device, personal communication device, short message service device or wireless communications device (e.g., a wireless personal digital assistant).

The MCS 102 may have, or be operatively connected to, a low battery level system 106 that provides for a network initiated call to the mobile phone to inform a mobile user of a low battery condition of the mobile phone, such as mobile station 112.

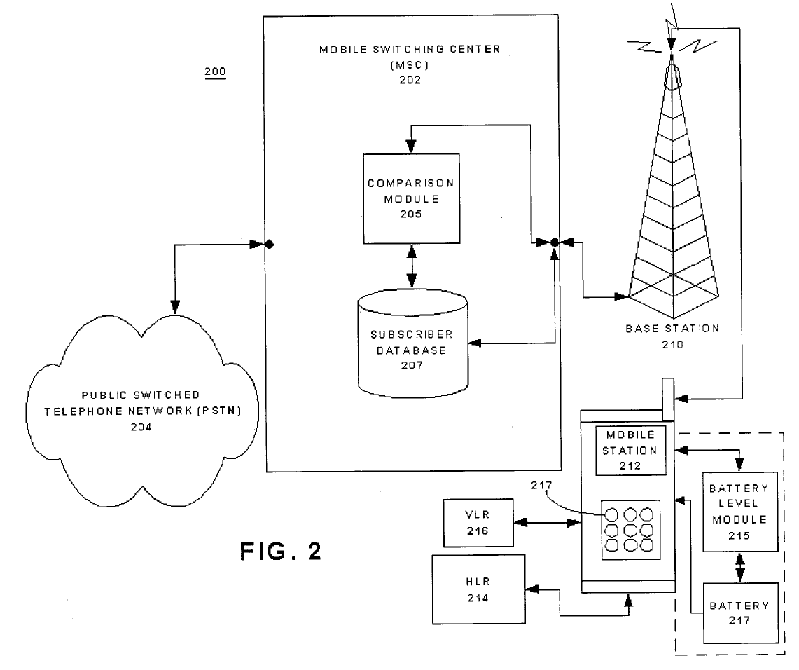

Referring to FIG. 2, a communication network or system 200 is shown for initiating a call to the mobile phone 212 to inform a mobile user of a low battery condition of the mobile phone 212. FIG. 2 depicts a block diagram that is illustrative of a mobile switching center 202 operatively connected a PSTN 204, base station 210, and mobile station 212 according to one embodiment of the present method and system. The MSC 202 is connected to one or more base stations 210. The base station(s) 210 communicates through the air to mobile stations 212, which may be, for example, of a cellular telephone type or of the wider bandwidth personal communication device type. Mobile stations 212 may in general be any type of battery powered communication device.

In the FIG. 2 embodiment, the battery powered communication device has a battery level monitoring module 215, the battery level monitoring module 215 outputting a current battery level of a battery 217. A pilot strength measurement message, containing at least the current battery level, is sent from the battery powered communication device 212 to the base station 210, and the base station 210 forwards the current battery level of the mobile phone to the mobile switching center 202 in the communication network 200.

In an embodiment of the present method and system the PSMM message may be modified to provide for an additional field for transmitting the current battery level of the mobile phone. The PSMM message is transmitted from the mobile to the base station 210 and then the battery condition information contained in the modified PSMM message will be forwarded from the base station 210 to the Mobile Switching Center (MSC) 202. Currently no PSMM message information is utilized by the MSC.

A comparison module 205 in the mobile switching center 202 in the communication network 200 compares the current battery level of the battery 217 to at least one stored predetermined battery level in a subscriber database 207. The telecommunication network 200, via a network initiated call to the battery powered communication device 212, effects at least one predetermined action (that also may be stored in the subscriber database 207) at the battery powered communication device 212 in response to a transgression of the at least one predetermined battery level condition by the current device battery level condition of the battery powered communication device 212.

A mobile user may define, for example, two threshold levels for the battery power. At one level the mobile phone would receive a pre-recorded low battery message from the network, informing the mobile user of a low battery level condition. At the next threshold, the mobile user would receive an automatic, network initiated instruction to put the mobile phone into a hibernation mode in order to save what little battery power may be left.

“Hibernation” is a power management technology, which enables input to a system (such as a mobile phone) to be completely stopped. In general, the system is triggered to shift to a hibernation state by interrupting a task under execution when a key/mouse input or the activity of I/O device is not detected over more than a predetermined length of time or the battery is in a low battery state. Restoration of a system from the hibernation mode is termed “wake up”. The “wake up” restores the system to an original state to resume the task.

The predetermined action may be, for example, at least one of: initiating a low battery reminder call to the battery powered communication device; placing the battery powered communication device into a hibernation mode; sending a notification of a low battery condition to the battery powered communication device; and providing an override option at the battery powered communication device before placing the battery powered communication device into the hibernation mode.

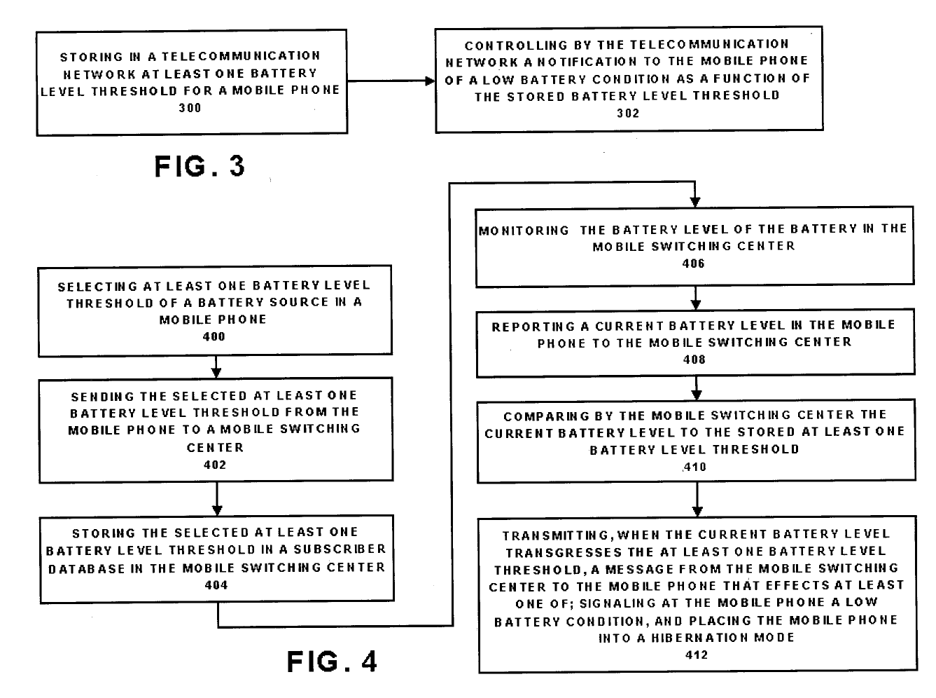

FIG. 3 is a block diagram depicting an embodiment of the present method. In very general terms the method has the steps of: storing in a telecommunication network at least one battery level threshold for a mobile phone (step 300); and controlling by the telecommunication network a notification to the mobile phone of a low battery condition as a function of the stored battery level threshold (step 302).

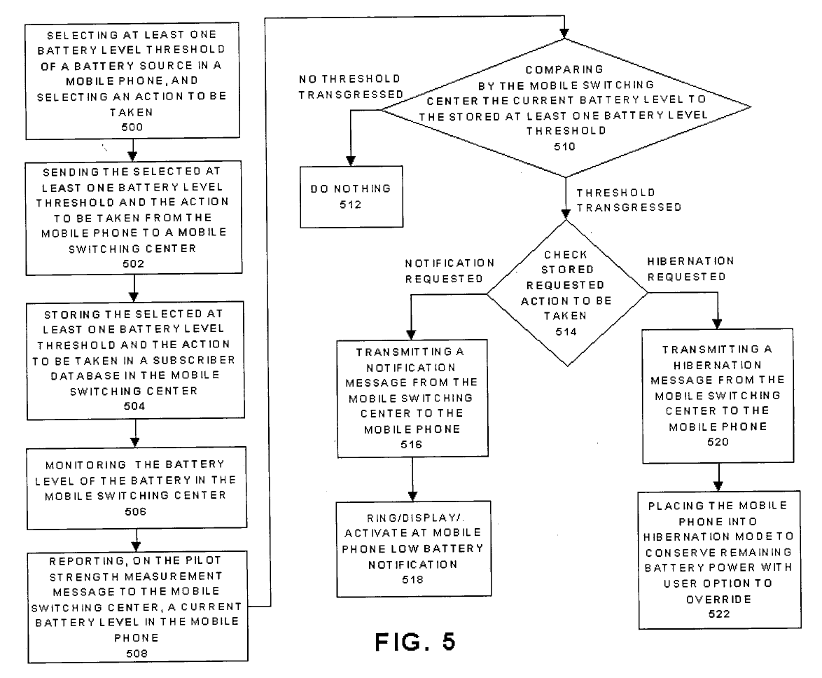

FIG. 4 is a block diagram depicting another embodiment of the present method. This embodiment of the method in a telecommunications network has the steps of: selecting at least one battery level threshold of a battery source in a mobile phone (step 400); sending the selected at least one battery level threshold from the mobile phone to a mobile switching center (step 402); storing the selected at least one battery level threshold in a subscriber database in the mobile switching center (step 404); monitoring the battery level of the battery in the mobile switching center (step 406); reporting a current battery level in the mobile phone to the mobile switching center (step 408); comparing by the mobile switching center the current battery level to the stored at least one battery level threshold (step 410); and transmitting, when the current battery level transgresses the at least one battery level threshold, a message from the mobile switching center to the mobile phone that effects at least one of, signaling at the mobile phone a low battery condition, and placing the mobile phone into a hibernation mode (step 412).

FIG. 5 is a block diagram depicting yet another embodiment of the present method. In this embodiment of the method, the method has the steps of: selecting at least one battery level threshold of a battery source in a mobile phone, and selecting an action to be taken (step 500); sending the selected at least one battery level threshold and the action to be taken from the mobile phone to a mobile switching center (step 502); storing the selected at least one battery level threshold and the action to be taken in a subscriber database in the mobile switching center (step 504); monitoring the current battery level of the mobile phone in the mobile switching center (step 506); reporting on the PSMM ultimately to the Mobile Switching Center, a current battery level in the mobile phone (step 508); comparing by the mobile switching center the current battery level to the stored at least one battery level threshold (step 510); if no threshold is transgressed, then no action occurs (step 512); if a threshold is transgressed, then a check is made to identify a stored requested action that is to be taken (step 514); if, for example, notification is requested, notification message is transmitted from the mobile switching center to the mobile phone (step 516), and then the action of ring/display/activate a mobile phone low battery notification occurs at the mobile phone (step 518); if, for example, hibernation is requested, then transmitting a hibernation message from the mobile switching center to the mobile phone (step 520), and then the mobile phone is placed into hibernation mode to conserve remaining battery power with a user option to override. It is to be understood that other predetermined actions may be taken (step 522).

The present system and method may be used with non-mobile phones, as well as, mobile phones. Also, different types of data storage devices may be used with the present method and system. For example, a data storage device may be one or more of a magnetic, electrical, optical, biological, and atomic data storage medium. The present invention overcomes the drawbacks of the prior art and provides an improved method and system in a telecommunications network for notification to a battery powered communication device from a telecommunications network of a low battery condition of the battery powered communication device.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

We claim:

1. A method for providing notification to a battery powered communication device from a telecommunications network of a low battery condition of the battery powered communication device, said method comprising the steps of:
defining, by a battery powered communication device, at least one predetermined battery level condition at; and
controlling, by the communication network, notification of a transgression of the at least one predetermined battery condition by a current device battery level condition of the battery powered communication device.

2. The method of claim 1 further comprising the steps of:
sending the at least one predetermined battery level to the communication network; and
storing the at least one predetermined battery level at the communication network.

3. The method of claim 2, wherein the at least one predetermined battery level condition is sent to the communication network via a pilot strength measurement message.

4. The method of claim 1, wherein the method further has the step of effecting, by the telecommunication network via a network initiated call to the battery powered communication device, at least one predetermined action at the battery powered communication device in response to the transgressing of the at least one predetermined battery level condition by a current device battery level condition of the battery powered communication device.

5. The method of claim 4, wherein the action is at least one of:
initiating a low battery reminder call to the battery powered communication device;
placing the battery powered communication device into a hibernation mode;
sending a notification of a low battery condition to the battery powered communication device; and
providing an override option at the battery powered communication device before placing the battery powered communication device into the hibernation mode.

6. The method of claim 1, wherein a plurality of predetermined battery level conditions is stored at the communication network.

7. The method of claim 1 wherein the battery powered communication device is a cell phone.

8. A method for providing a network initiated call to a battery powered communication device from a telecommunications network to inform of a low battery condition of the battery powered communication device, said method comprising the steps of:
monitoring a device battery level condition of a battery powered communication device;
determining, by a telecommunication network, when the device battery level condition of the battery powered communication device transgresses at least one predetermined battery level condition; and
effecting, by the telecommunication network via a network initiated call to the battery powered communication device, at least one predetermined action at the battery powered communication device in response to the transgression of the at least one predetermined battery level condition by the current device battery level condition of the battery powered communication device.

9. The method of claim 8 further comprising the steps of:
defining the at least one predetermined battery level condition at the battery powered communication device;
sending the at least one predetermined battery level to the communication network; and
storing the at least one predetermined battery level at the communication network.

10. The method of claim 8, wherein the action is at least one of:
initiating a low battery reminder call to the battery powered communication device;
placing the battery powered communication device into a hibernation mode;
sending a notification of a low battery condition to the battery powered communication device; and
providing an override option at the battery powered communication device before placing the battery powered communication device into the hibernation mode.

11. The method of claim 8, wherein a plurality of predetermined battery level conditions is stored at the communication network.

12. The method of claim 8, wherein the battery powered communication device is a cell phone.

13. The method of claim 8, wherein the at least one predetermined battery level condition is defined at the battery powered communication device;
wherein the at least one predetermined battery level condition is sent to the communication network, wherein the at least one predetermined battery level condition is stored at the communication network; and
wherein the communication network controls notification to the battery powered communication device of a low battery condition.

14. The method of claim 13, wherein the at least one predetermined battery level condition is sent to the communication network via a pilot strength measurement message.

15. A system for providing a network initiated call to a battery powered communication device from a telecommunications network to inform of a low battery condition of the battery powered communication device, comprising:
a communication network operatively connected to a battery powered communication device;
the battery powered communication device having a battery level monitoring module, the battery level monitoring module outputting a current battery level indicative thereof;
a pilot strength measurement message containing at least the current battery level, the pilot strength measurement message being sent from the battery powered communication device to the communication network; and
a comparison module in the communication network, wherein the comparison module compares the current battery level to at least one stored predetermined battery level;
wherein the telecommunication network, via a network initiated call to the battery powered communication device, effects at least one predetermined action at the battery powered communication device in response to the transgression of the at least one predetermined battery level condition by the current device battery level condition of the battery powered communication device.

16. The system of claim 15, wherein the communication network further comprises a subscriber database for storing the at least one predetermined battery level condition.

17. The system of claim 15, wherein the communication network further comprises a subscriber database for storing the at least one predetermined action.

18. The system of claim 15, wherein the communication network further comprises a subscriber database for storing the at least one predetermined battery level condition and the at least one predetermined action.

19. The system of claim 15, wherein the system comprises a plurality of actions, and wherein the action is at least one of:
initiating a low battery reminder call to the battery powered communication device;
placing the battery powered communication device into a hibernation mode;
sending a notification of a low battery condition to the battery powered communication device; and
providing an override option at the battery powered communication device before placing the battery powered communication device into the hibernation mode.

20. The method of claim 15, wherein the battery powered communication device is a cell phone.
